(19) United States
(12) Patent Application Publication
(10) Pub. No.: US 2021/0015129 A1
(43) Pub. Date: Jan. 21, 2021

(54) METHOD AND APPARATUS FOR PREPARING AN EDIBLE FOOD OR BEVERAGE PRODUCT

(71) Applicant: SOCIETE DES PRODUITS NESTLE S.A., Vevey (CH)

(72) Inventor: Youcef Ait Bouziad, Echandens (CH)

(21) Appl. No.: 17/042,424

(22) PCT Filed: Apr. 25, 2019
(86) PCT No.: PCT/EP2019/060685

§ 371 Date: Sep. 28, 2020

(30) Foreign Application Priority Data
Apr. 30, 2018 (EP) 18170099.8

(51) Int. Cl. A23L 5/10; A47J 27/00

(52) U.S. Cl. CPC A23L 5/13; A47J 27/00

(57) ABSTRACT

The invention relates to an apparatus (100) for preparing an edible food or beverage product starting from dehydrated raw material and comprising at least two complementary zones (10, 20) where a certain raw material, or series of it, is processed in at least two steps, the two zones (10, 20) being defined as:—a primary zone (10) receiving one or a series of raw dehydrated material and a fluid, typically water, comprising primary processing means (13) and shaping means (15) configured to process and to dispense the processed product into a secondary zone;—a secondary zone (20) receiving the one or multitude of processed products from the primary zone (10) comprising distinct secondary processing means (22) and distinct heating means (23), the secondary zone (20) being configured to process further the products from the primary zone (10) into their final configuration; both zones (10, 20) working in a complementary way according to a certain recipe, such that each of the distinct processing means (13, 22), the shaping means (15) and the heating means (23) in the primary and secondary zones (10, 20) are independently actuated to obtain the targeted results in each zone as dictated by the recipe; and such that the raw material, or series of it, is processed in at least two steps as rehydration and/or structuration and/or forming in the primary zone (10) as a primary transformation; and shredding and/or cooking and/or cooling in the secondary zone (20) as a secondary and final transformation. The invention further relates to a method for preparing an edible food or beverage product starting from dehydrated raw material and using an apparatus (100) as described.

### FIELD OF THE INVENTION

The present invention is directed to an apparatus for preparing an edible food or beverage product starting from dehydrated raw material and comprising at least two complementary zones. The invention is further directed to a method for preparing an edible food or beverage product using such an apparatus.

### BACKGROUND OF THE INVENTION

Dried or semi-dried food products, typically configured as powders, are used very frequently in the food industry: they represent compact and hygienic ways of storing an initial component of a food product that will be subsequently processed, for example by mixing and adding water or any other liquid, being therefore reconstituted.

There exist in the state of the art food processing systems that prepare edible layers of food starting from raw food materials, typically in powder. For example, document EP 16722568.9 of the applicant discloses a food processing system comprising a plurality of containers, each container comprising a certain raw food material, typically a powder. Each container is associated to a processing and dispensing unit: the initial raw material from the container goes into the specific unit where it is processed typically by adding water and the resulting mixture is turned into a homogeneous mass before being deposited as a layer onto a depositing area, where the layer can be optionally further cooked and/or heated.

It is known also from the applicant document PCT/EP17/076941 disclosing a food processing management system: the system comprises a control unit connected to a dosing system for exchanging containers, each container comprising a certain type of dehydrated food material, typically a powder, that is sent into a processing and dispensing unit where it is mixed with water and turned into a homogeneous mass that will be deposited as a layer onto a depositing area, the layer being later optionally heated and/or cooked.

The food processing systems described earlier have many advantages but also present certain limitations. Particularly, it would be desireable to provide a system that will allow working in batches, i.e., while a certain mixture has been deposited and is being processed and cooked, for example, a second mixture is being prepared in parallel. Thus, a batch processing is desirable, as the residence time can be controlled according to a certain recipe. On the contrary, an in-line system (i.e. a system working on demand) as the one disclosed in PCT/EP17/076941, not working in batches, would need very complex, long and extended configurations for arriving to control the process as it is the case in the present invention, further controlling the processing parameters of each product differently, also according to the final desired recipe. Also, it would be desireable to provide a final food or beverage as a final dish, configuring a complete dish meal, with certain complexity: for example, the final dish can comprise a liquid foodstuff, a nutritious bulk material, chunk pieces or others.

Soup maker devices are also known in the state of the art: these systems comprise one preparation zone where a soup product is prepared typically by mixing a powder ingredient with water, the mixture being further cooked and/or heated. However, these systems are only able to provide very limited recipes, as they have only one zone of preparation.

Furthermore, it would be desireable that the consumer can add fresh ingredients of his/her own to the final dish prepared, and at the moment in time when he/she wishes to do so. Moreover, it would be also desireable to be able to provide different textures for the foodstuff products and also personalized and nutritionally balanced final recipes. Therefore, one of the aims of the present invention is to provide personalised and complex recipes by using an automated and yet simple and compact configuration.

The present invention aims at overcoming the limitations mentioned in the existing food processing systems. The invention also aims at other objects and particularly the solution of other problems as will appear in the rest of the present description.

### OBJECT AND SUMMARY OF THE INVENTION

According to a first aspect, the invention relates to an apparatus for preparing an edible food or beverage product starting from dehydrated raw material and comprising at least two complementary zones where a certain raw material, or series of it, is processed in at least two steps. The two zones are defined as: a primary zone receiving one or a series of raw dehydrated material and a fluid, typically water, comprising primary processing means and shaping means configured to process and to dispense the processed product into a secondary zone; a secondary zone receiving the one or multitude of processed products from the primary zone comprising distinct secondary processing means and heating means (broadly understood as thermal means), the secondary zone being configured to process further the products from the primary zone into their final configuration. Both zones work in a complementary way (coordinated or synchronized way) according to a certain recipe, such that each of the distinct processing means, the shaping means and the heating means in the primary and secondary zones are independently actuated to obtain the targeted results in each zone as dictated by the recipe. According to the invention, the raw material, or series of it, is processed in at least two steps as rehydration and/or structuration and/or forming in the primary zone as a primary transformation; and shredding and/or cooking and/or cooling in the secondary zone as a secondary and final transformation.

Preferably, in the apparatus for preparing an edible food or beverage product starting from dehydrated raw material according to the invention, the shaping means further comprise heating means (broadly thermal means).

Typically, the primary zone is configured to process the dehydrated raw material by mixing, dissolution, reconstitution, structuration, kneading, heating, cooling, or any other process to transform the raw product into a different physical and/or chemical state such as liquid mixture, suspension, emulsion, foam, paste, dough, or the like.

Also typically, in the apparatus according to the present invention, the secondary zone receiving the one or multitude of processed products from the primary zone is configured to process them by mixing, dissolution, reconstitution, structuration, kneading, heating, cooling, blending or any other process to transform the product into another physical and/or chemical state such as liquid mixture, suspension, emulsion, foam, paste, dough, or the like.

According to the invention, the apparatus for preparing an edible food or beverage product starting from dehydrated raw material further comprises a control unit receiving the information on the recipe and the parameters to be applied to process accordingly the product in each of the zones, such that the control unit manages independently the operation of the primary and secondary zones according to these parameters.

Preferably, the primary and secondary zones in the apparatus of the invention are operated sequentially or simultaneously depending on the different steps in the preparation process, according to the recipe targeted.

Typically, the primary and secondary zones in the apparatus of the invention are independently controlled or managed by the control unit in particular as to water addition and/or rotational speed of the processing means and/or their rotational direction, as well as to the temperature and/or the mode (heating, cooling) of the heating means.

Preferably, the apparatus of the invention is further connected to a database providing the parameters to process the product in each of the primary and secondary zones, the different steps of preparation on each zone being dictated by a timer.

Typically, the different steps for the preparation on each of the zones in the apparatus of the present invention are based on triggered values such as product temperature and/or viscosity and/or weight for each of the zones. Preferably, the database is a user database and/or an external database and/or an apparatus or machine database.

According to the present invention, the primary and secondary zones are typically configured to work in a synchronized way (complementary, coordinated way) providing a final prepared product as a heterogeneous medium comprising at least two distinct phases or physical states of the same or of different products, such as an aqueous or viscous phase comprising a soup, a sauce or the like, and a solid phase comprising a dough, a paste, chunks or the like.

In the apparatus of the invention, preferably, the primary and secondary zones are configured to work in a synchronized way such that the first product to be prepared and dispensed from the primary zone to the secondary zone is in a form of an aqueous or viscous phase defined as a container phase, able to receive the second product that will be prepared by the primary zone in a form of a solid or bulk phase, defined as a content phase, that will be processed together in the secondary zone into their final configuration.

According to a second aspect, the invention relates to a method for preparing an edible food or beverage product starting from dehydrated raw material and using an apparatus as the one previously described, the method comprising the steps of:
retrieving recipe parameters from a database according to which the apparatus will operate;
transforming a certain quantity of raw material in the primary zone for rehydration and/or structuration and/or forming of the raw material, as to a certain level, indicated by the recipe parameters;
dispensing the transformed material into the secondary zone;
processing the product delivered as to shredding and/or cooking and/or cooling in the secondary zone according to a certain level, indicated by the recipe parameters;
simultaneously or consequently (successively) transforming a second quantity of raw material in the primary zone with respect to the processing taking place for the first quantity of raw material in the secondary zone;
dispensing the second quantity of raw material processed in the primary zone into the secondary zone for shredding and/or cooking and/or cooling according to the recipe;
repeating the precedent steps a plurality of times depending on the information from the recipe parameters until a certain homogeneous or heterogeneous mixture is achieved.

Preferably, in the method of the invention, a final processing is applied in the secondary zone to the mixture therein comprised, to get a homogeneous or heterogeneous mixture according to the recipe targeted and obtain a final product.

Typically, in the method according to the present invention, the user can further add food or beverage products into the secondary zone, at any time of the processing carried out in the apparatus, as dictated by the recipe.

Preferably, in the method according to the invention, the database defines the following features for the preparation of the end product in the apparatus:
ordering raw products to be dispensed into and processed in the primary zone;
processing requirements needed per raw product dispensed in the primary zone;
timing and/or triggering values for dispensing the products from the primary zone into the secondary zone;
processing requirements needed per product and/or mixture into the secondary zone.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows a cut view of the apparatus for preparing and edible food or beverage product according to the present invention.

FIGS. 2A-D show different details of the main elements configuring the apparatus for preparing an edible food or beverage product according to the invention.

FIGS. 3A-B show schematically the preparation of a food or beverage product in the secondary zone in an apparatus for preparing an edible food or beverage product according to the invention.

FIG. 4 shows a simultaneous operation of the primary and secondary zones in an apparatus for preparing an edible food or beverage product according to the invention.

FIGS. 5A-B show schematically the dispensing of a food or beverage product prepared in the primary zone into the secondary zone, in an apparatus for preparing an edible food or beverage product according to the invention.

FIGS. 6A-B show schematically the dispensing of a food or beverage product prepared in a primary zone into a secondary zone, in an apparatus for preparing an edible food or beverage product according to the invention.

FIGS. 7A-B show the final preparation of a food or beverage product in an apparatus for preparing an edible food or beverage product according to the invention.

FIG. 8 shows a scheme with the operation of the apparatus for preparing an edible food or beverage product according to the invention.

### DETAILED DESCRIPTION OF EXEMPLARY EMBODIMENTS

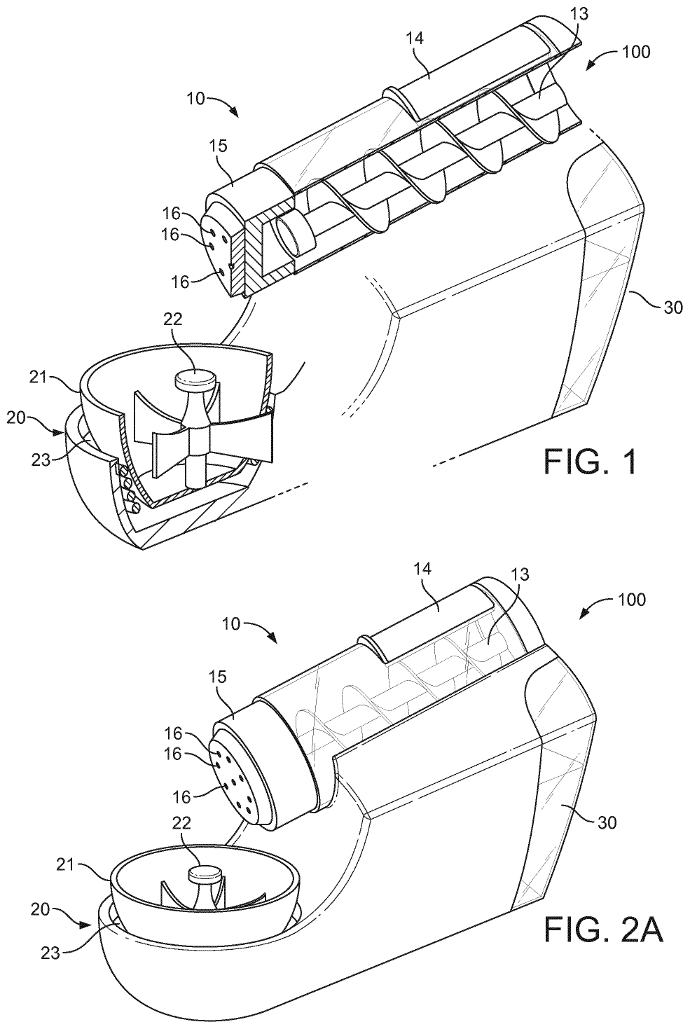

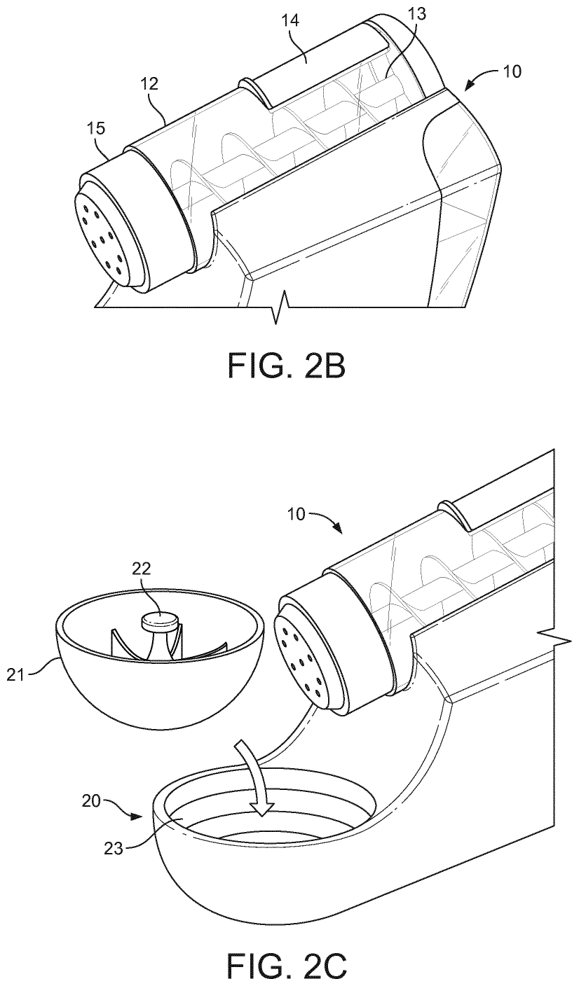

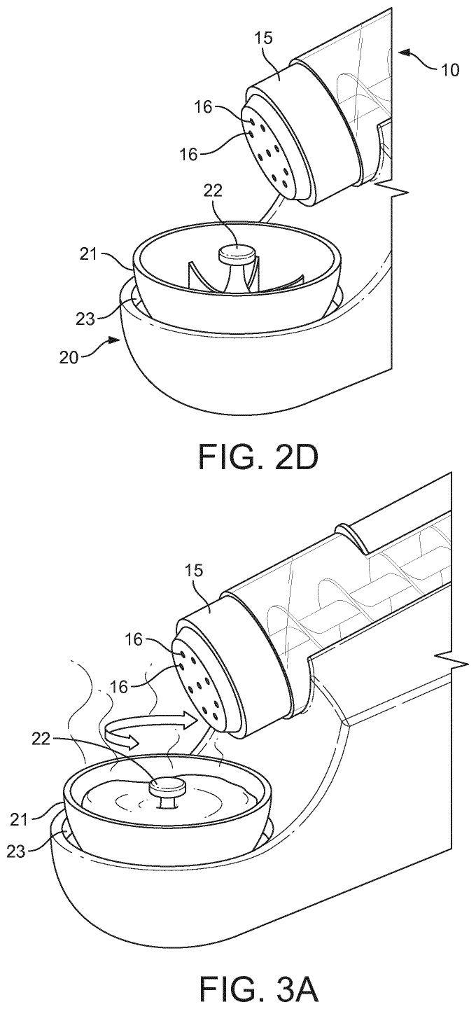

As represented in the cut view of FIG. 1 or on any of the FIGS. 2A to 2D, the present invention is directed to an apparatus 100 for preparing an edible food or beverage product starting from a dehydrated raw material and comprising at least two complementary zones, a primary zone 10 and a secondary zone 20, these two zones working in a complementary way, as it will be further explained in detail.

The primary zone 10 comprises a processing container 12 receiving through an aperture 14 a dehydrated raw material (or multiple ones) and a fluid, typically water. Primary processing means 13 are provided inside the processing container 12: these primary processing means 13 are preferably a mixer or the like, able to rotate and thus to mix and knead the raw food product and the water into a mixture, that can be a liquid mixture for example, or a dough-like product, that will then be conveyed into shaping means 15 and through a plurality of extruding holes 16, shaping the pasta-like product that will then be dispensed into the secondary zone 20. These shaping means 15 can take different shapes, particularly of the extruding holes 16, that will define according shapes of the poduct dispensed into the secondary zone 20. This shaping element can also be made interchangeable and thus able to shape differently the product dispensed. Optionally or additionally, the shaping means 15 can further be provided with heating means in order to heat the product when passing through this element and before it is dispensed into the secondary zone 20: this heating of the product also helps its shaping and delivering. Optionally, the shaping means can also be provided with cooling means to cool down the product passing though it before it is delivered into the container 21. The fluid, typically water, will be provided directly into the processing container 12 from a water tank 30, as shown in FIG. 1 or in FIG. 2A.

The secondary zone 20 comprises a secondary processing container 21, preferably made removeable from the secondary zone 20, as represented in FIG. 2C. This secondary processing container 21 further comprises secondary processing means 22, typically a blade, as represented in the Figures attached. The secondary processing means 22 are configured to rotate inside the container 21, with a speed and/or a rotation direction that depends according to the food or beverage product being processed and also according to the desired recipe. Moreover, the secondary zone 20 comprises heating means 23 arranged so as to match a certain external area of the secondary processing container 21, when this container is placed in the secondary zone 20, so the food or beverage product inside is heated and possibly cooked if desired, and depending on the targeted recipe. The user of the apparatus of the invention can always add, if he/she so desires, fresh products of his/her choice into the container 21, at any moment of the preparation of the recipe as dictated by the recipe; this provides a broad versatility of the apparatus of this invention. This heating means 23 can also be configured to cool instead the product in the container 21, so as to provide different textures and/or tasting for the final product.

The food or beverage product of the invention needs two steps processing such as reconstitution and/or dilution and/or rehydration and/or structuration and/or forming and/or heating in the primary zone 10, as a primary transformation, and shredding and/or heating and/or mixing and/or shredding and/or cooking and/or cooling and/or shaking and/or turning and/or texturizing in the secondary zone 20, as a secondary transformation.

One example of use of the apparatus of the invention will be for example, to provide a certain raw food product in powder in the primary zone 10 that will be mixed with water resulting in a soup mix that will be then dispensed into the secondary processing container 21, where the mix will be stirred and boiled into a cooked soup mix final product.

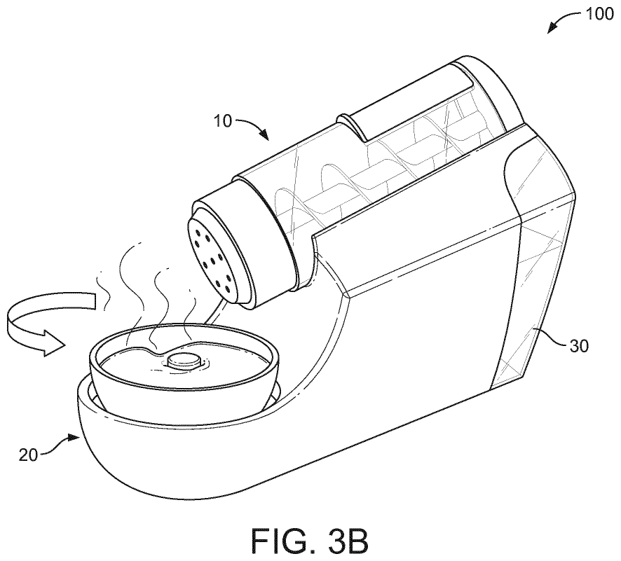

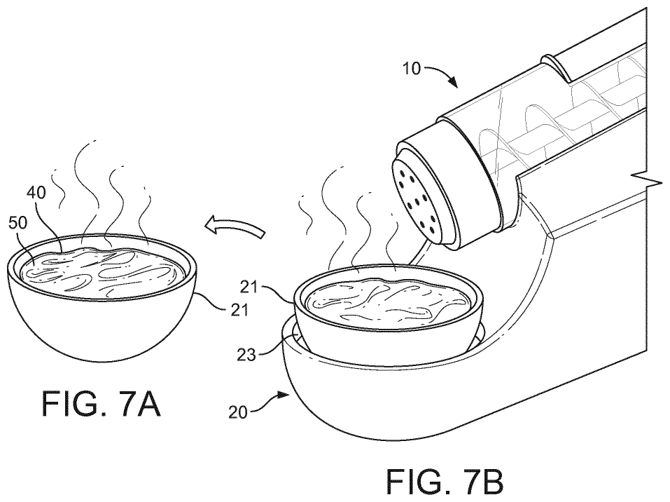

Another preferred example of use of the apparatus of the invention is to prepare first a liquid mixture of the soup type in the primary zone 10 that will be dispensed in the secondary processing container 21, where it will be cooked and/or heated: preferably, the container 21 will rotate to homogenise the soup while a second component of the recipe is prepared in the primary zone 10. In parallel, a mixture of the dough-type will be prepared in the primary zone 10 and will be dispensed into the container 21 in the shape of noodles, for example, shaped through exiting the shaping means 15 and going into the soup prepared in the container 21. The process for such a preferred recipe is exemplified in FIGS. 3A to 6B; the final recipe obtained being shown in FIGS. 7A-B.

Another example of use of the apparatus of the invention will be to provide in the primary processing container 12 a flower mix that will be mixed with water in order to form a dough-based mixture (like pasta, noodles, or the like) that will be dispensed into the secondary processing container 21. The user will add a sauce in this container 21 that will be mixed by stirring of the processing means 22. At the same time or consequently, the heating means 23 will be activated in order to cook the dish that will be provided as pasta in sauce.

Depending on the desired recipe and also on the desired texture of the product or products, the apparatus of the invention will be operated differently. More or less quantity of water will be added depending on the texture desired for the mixture prepared in the primary zone 10 for example, or a different rotational speed of the primary processing means 13 will be envisaged that will also result in a different product texture. Furthermore, heating of the product in the shaping means 15 will also influence the product texturization. The same applies for the processing in the secondary processing container 21: the rotational speed of the processing means 22 and the heating and/or cooling provided by the heating means 23 will similarly provide different textures of the product prepared.

The apparatus of the present invention allows an enormous versatility not only in the preparation of the dishes and in the textures of the products dispensed, but also in the election of the food components: different powders can be used, such as soy, other plant-based protein powders, wheat flour, rice powder or others. Typically, a flour and a fixing material are provided to make a proper food or beverage mixture. This allows providing personalized and nutritionally balanced meals. On top of this, the two zones of the apparatus of the invention work complementarily, simultaneously or sequentially, during the same process for preparing a certain dish, so that a further versatility is allowed. This will be more evident with the Description as it follows.

FIG. 3A or 3B show a step where the primary zone 10 has prepared and dispensed a certain food product into the secondary zone 20 (into the secondary processing container 21). The food product is then heated and cooked in this container 21 by the heating means 23 and, in order to provide homogeneous mixture, the processing means 22 rotate within the container 21, as shown by the arrows in FIGS. 3A and 3B. The rotational speed and/or the direction of rotation of the processing means 22 is set and controlled depending on the texture desired for the mixture prepared in the container 21.

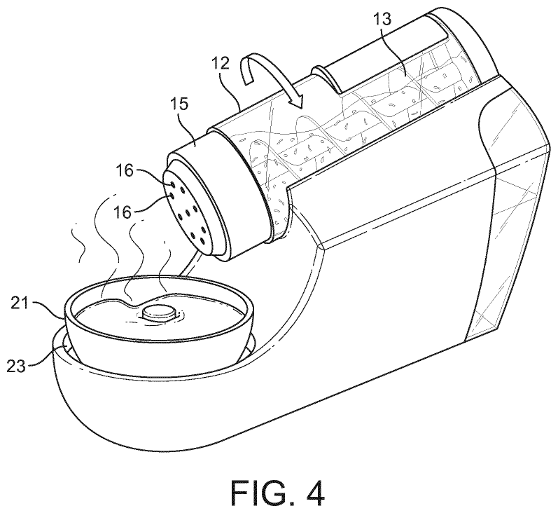

Looking now at FIG. 4, the simultaneous operation of the primary and secondary zones 10 and 20 is shown: a certain mixture has been prepared and delivered into the secondary processing container 21, and while it is being heated by the heating means 23, for example (the processing means 22 can be rotating also at the same time), a second batch of the same or of a different food material is being prepared in the processing container 12, as exemplified by the arrow in this Figure.

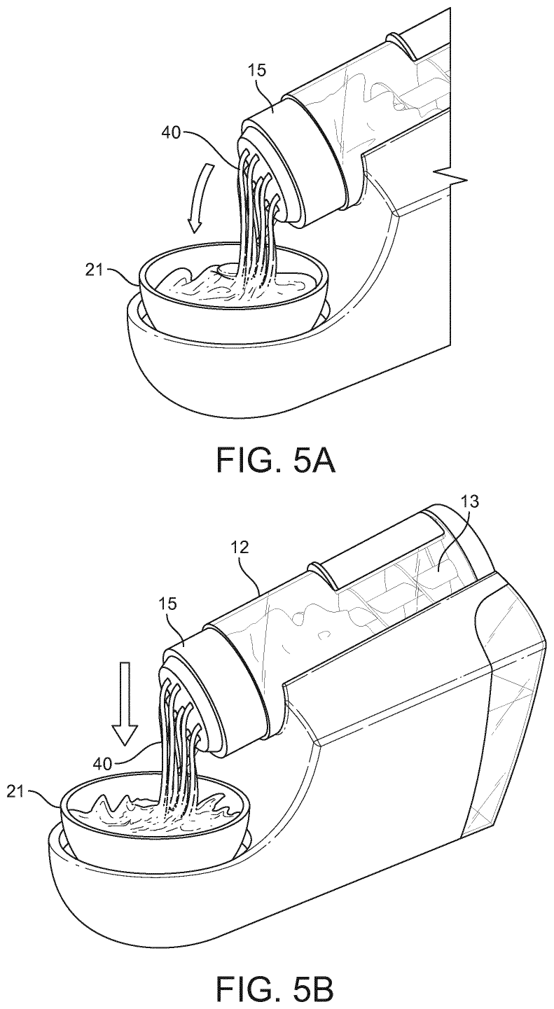

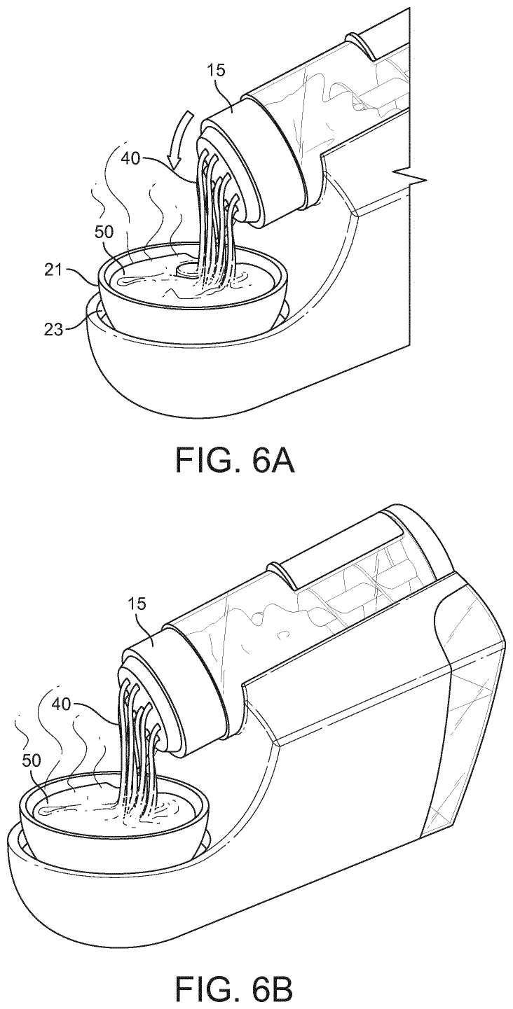

Turning now to FIGS. 5A and 5B, once a certain food product mixture has been prepared in the primary processing container 12, it is then extruded through the shaping means 15 as an extruded food product 40, having a certain shape depending on the configuration of the means 15. The product 40 is dispensed into the secondary processing container 21. FIGS. 6A and 6B show the extruded product 40 sent into the secondary processing container 21 where this product is heated and/or cooked by the heating means 23 into a product 50, with a certain texture and/or homogeneity that in this example is a kind of a soup product. While the soup product is heated in the container 21, a further extruded product is prepared in the primary processing container 12 having the configuration of pasta noodles, for example, which are dispensed into the already prepared soup 50 in the container 21, configuring a final dish of soup with noodles: FIGS. 7A and 7B show the configuration of the final product (soup 50 and noodles added 40) provided in the container 21: for convenience, this container 21 is preferably made removable from the apparatus 100 so the prepared dish can be also consumed directly from there. The processing means 22 are typically also removable from the container 21.

Therefore, the apparatus of the present invention allows the preparation of versatile recipes: for example, the final prepared product can be in the form of a heterogeneous medium at least composed by two distinct phases or physical states such as an aqueous or viscous phase, such as soup or a sauce and a solid phase such as a dough, paste, chunks or the like. For example, the first product to be prepared and dispensed from the primary zone 10 into the secondary zone 20 can be in a form of an aqueous or viscous phase defined as a container phase, able to receive the second product in a form of a solid or bulk phase, defined as a content (disperse phase) phase, to be cooked together in the secondary zone 20.

In the apparatus of the invention, the primary and secondary zones 10 and 20 are configured to work in a complementary way and/or typically in a master-slave and/or slave-master way depending on the recipe to prepare the final dish. The operations taking place in these two zones 10 and 20 are based on one or a multitude of schemes and interactions, managed by a control unit 400 in order to achieve the targeted results, as each zone further comprises distinct processing means, 13 and 22, managed independently by the control unit.

The apparatus 100 of the invention is further connected to a database (that can be provided in the apparatus directly, or it can be an external database instead) comprising the recipe preparation data for a multitude of raw food products, this database defining a method of preparation of an end product according to several preparation steps, typically governed by time and/or by triggering preparation values such as temperature, viscosity, weight, etc. of the product in each of the zones 10 and 20.

Furthermore, the invention is also directed to a method for preparing a food or beverage product using a food processing apparatus 100 as the one described previously.

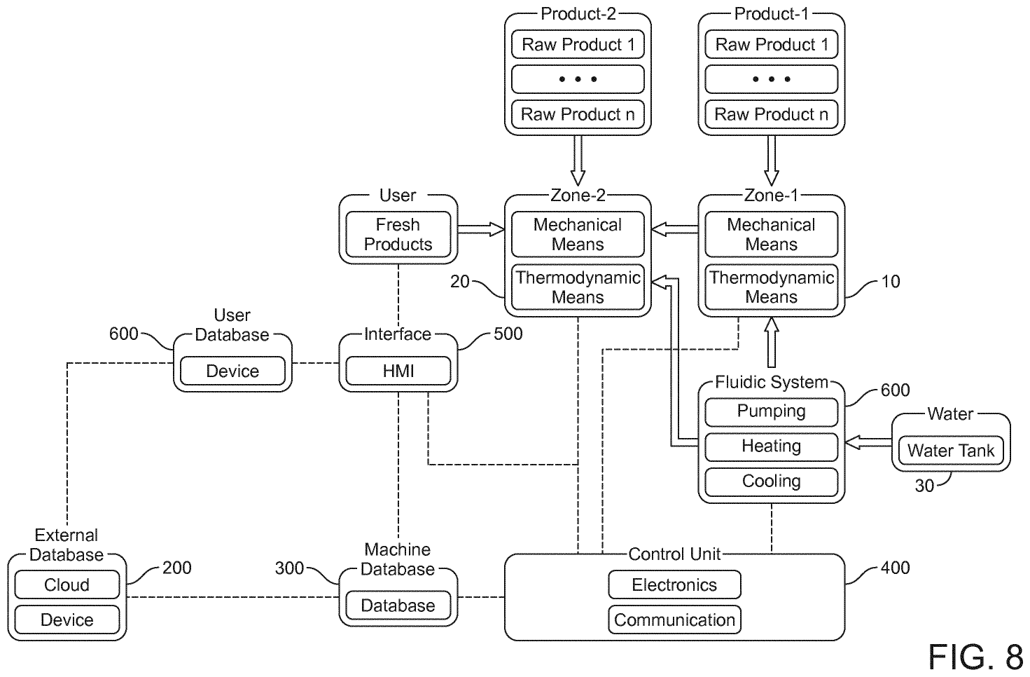

The method according to the present invention will now be described in detail by making reference to FIG. 8. A first product (raw food product) is delivered to the primary zone 10, in particular into the primary processing container 12: the first product can be a single raw food product or a mixture of a plurality of different raw food products. As shown in FIG. 8, this primary zone 10 can comprise both mechanical means and thermodynamic means: the mechanical means will preferably comprise processing means 13, typically shaped as a rotating mixer, of the screw type for example, a motor or driving means and an actuator; the thermodynamic means will comprise the heating or cooling technology to heat or cool down the food material prepared before it is delivered into the container 21 in the secondary zone 20. Preferably, the thermodynamic means are provided embedded in the shaping means 15 and are configured to achieve a certain temperature of the food material and/or to maintain it: the thermodynamic means preferably comprise a thermobloc, a heat exchanger or the like. The water tank 30 provided in the apparatus of the invention is connected to a fluidic system 600 configured to carry out the operations of pumping and/or heating and/or cooling the water that is delivered. Preferably, the fluid (water) will be dispensed into the primary zone 10 (into the primary processing container 12) but it can also be dispensed into the secondary zone 20 (particularly, into the secondary processing container 21). As described, the water can be provided into the containers 12 or 21 at a desired temperature, hot, ambient or cold.

Similarly as to what has been described for the primary zone 10, a second product (raw food product) is delivered to the secondary zone 20, in particular into the secondary processing container 21: the second product can be a single raw food product or a mixture of a plurality of different raw food products. This secondary zone 20 can comprise both mechanical means and thermodynamic means: the mechanical means will preferably comprise processing means 22, typically shaped as rotating blades, a motor or driving means and an actuator; the thermodynamic means 23 will comprise the heating or cooling technology to heat or cool down the food material prepared in the container 21 in the secondary zone 20. Preferably, the thermodynamic means are provided embedded in an area in the secondary zone 20 that will match a certain external area of the container 21 in order to heat and/or cool down the food material prepared inside the container 21. These heating means 23 are configured to achieve a certain temperature of the food material and/or to maintain it: the thermodynamic means preferably comprise a thermobloc, a heat exchanger or the like.

The primary and secondary zones 10, 20 of the apparatus 100 of the invention can work simultaneously or sequentially, and can also vary this operational mode depending on the different steps of the recipe preparation. Advantageously, once a first food mixture has been prepared in the primary zone 10 and has been delivered into the container 21 in the secondary zone 20, while this mixture is being cooked and/or heated (for example) in the secondary zone, a further batch of food material is being processed and prepared in the primary zone 10: this way of operation allows faster recipe preparation, contrary to the known systems in the prior art.

As represented in FIG. 8, the user can also add fresh products in the secondary zone 21, if he/she so desires, and at the desired moment of the recipe preparation dictated by the recipe.

The apparatus of the invention carries out a method following one or a plurality of processing steps in order to provide a certain final dish: the recipe parameters are dictated by the recipe information, which is provided to the apparatus interface 500 in several possible ways, as represented in the attached FIG. 8: by a user database 600 (from a user's device, such as a tablet, a smart phone or the like), from an external database 200 (comprised in a cloud or in the user's device) or directly from the apparatus or machine database 300.

The information on the recipe as to steps to be carried out, products to be added into the primary and/or secondary zones 10, 20, timings for processing the food materials in these zones and/or triggering parameters such as temperature and/or viscosity and/or weight for example are contained in the recipe information in any of these databases, and are managed by a control unit 400 also provided in the apparatus 100 of the invention. The control unit 400 is provided with electronics for such a control and also with a communication module in order to show the information on the HMI interface 500.

As discussed earlier, the two zones 10 and 20 act independently though in a complementary manner so the operation of the system is very versatile. Each zone is controlled in operation by the central control unit 400 of the apparatus, in particular as to water addition in each zone, quantity added of water, rotational speed and/or direction of the processing means in each of the zones, temperature control and temperature mode (heating or cooling mode), amongst other parameters. The personalization and versatility provided by this operation is one of the main advantages of the apparatus and method presented in this invention.

In particular, the main feature providing the most differentiated advantages of the apparatus and method of the present invention comes from having two distinct preparation zones working in a complementary manner. Each of the zones excels in a certain type of preparation, allowing the control unit to decide, for each food type, where the process will take place: in the primary zone 10 or in the secondary zone 20 or even in both of the zones 10 and 20. The two zones in the apparatus of the invention work in a synergistic manner: such complementary processes in these zones allow a very broad and versatile recipes preparation without the need of using any other extra device, as it would be the case in the systems of the prior art.

Although the present invention has been described with reference to preferred embodiments thereof, many modifications and alternations may be made by a person having ordinary skill in the art without departing from the scope of this invention which is defined by the appended claims.

1. Apparatus for preparing an edible food or beverage product starting from dehydrated raw material and comprising at least two complementary zones where a certain raw material, or series of it, is processed in at least two steps, the two zones comprising:
a primary zone receiving one or a series of raw dehydrated material and a fluid, typically water, comprising primary processing means and shaping means configured to process and to dispense the processed product into a secondary zone;
a secondary zone receiving the one or multitude of processed products from the primary zone comprising a distinct secondary processing member and a heating member, the secondary zone being configured to process further the products from the primary zone into their final configuration;
wherein both zones work in a complementary way according to a certain recipe, such that each of the distinct processing member, the shaping member and the heating member in the primary and secondary zones are independently actuated to obtain the targeted results in each zone as dictated by the recipe; and
such that the raw material, or series of it, is processed in at least two steps as rehydration and/or structuration and/or forming in the primary zone as a primary transformation; and shredding and/or cooking and/or cooling in the secondary zone as a secondary and final transformation.

2. Apparatus for preparing an edible food or beverage product starting from dehydrated raw material according to claim 1 wherein the shaping member further comprise a heating member.

3. Apparatus for preparing an edible food or beverage product starting from dehydrated raw material according to claim 1 wherein the primary zone is configured to process the dehydrated raw material by a process selected from the group consisting of mixing, dissolution, reconstitution, structuration, kneading, heating, cooling, and any other process to transform the raw product into a different physical and/or chemical state.

4. Apparatus for preparing an edible food or beverage product starting from dehydrated raw material according to claim 1 wherein the secondary zone receiving the one or multitude of processed products from the primary zone is configured to process them by a process selected from the group consisting of mixing, dissolution, reconstitution, structuration, kneading, heating, cooling, blending or any other process to transform the product into another physical and/or chemical state.

5. Apparatus for preparing an edible food or beverage product starting from dehydrated raw material according to claim 1 further comprising a control unit receiving the information on the recipe and the parameters to be applied to process accordingly the product in each of the zones, the control unit managing independently the operation of the primary and secondary zones according to these parameters.

6. Apparatus according to claim 5 wherein the primary and secondary zones are operated sequentially or simultaneously depending on the different steps in the preparation process, according to the recipe targeted.

7. Apparatus according to claim 5 wherein the primary and secondary zones are independently controlled by the control unit.

8. Apparatus for preparing an edible food or beverage product starting from dehydrated raw material according to claim 1 further connected to a database providing the parameters to process the product in each of the primary and secondary zones, the different steps of preparation on each zone being dictated by a timer.

9. Apparatus according to claim 8 wherein the different steps for the preparation on each of the zones are based on triggered values such as product temperature and/or viscosity and/or weight for each of the zones.

10. Apparatus according to claim 8 wherein the database is a user database and/or an external database and/or an apparatus or machine database.

11. Apparatus according to claim 1 wherein the primary and secondary zones are configured to work in a synchronized way providing a final prepared product as a heterogeneous medium comprising at least two distinct phases or physical states of the same or of different products.

12. Apparatus according to claim 1 wherein the primary and secondary zones are configured to work in a synchronized way such that the first product to be prepared and dispensed from the primary zone to the secondary zone is in a form of an aqueous or viscous phase defined as a container phase, able to receive the second product that will be prepared by the primary zone in a form of a solid or bulk phase, defined as a content phase, that will be processed together in the secondary zone into their final configuration.

13. Method for preparing an edible food or beverage product starting from dehydrated raw material and using an apparatus, the method comprising the steps of:
retrieving recipe parameters from a database according to which the apparatus will operate;
transforming a certain quantity of raw material in a primary zone for rehydration and/or structuration and/or forming of the raw material, as to a certain level, indicated by the recipe parameters;
dispensing the transformed material into a secondary zone;
processing the product delivered as to shredding and/or cooking and/or cooling in the secondary zone according to a certain level, indicated by the recipe parameters;
simultaneously or consequently transforming a second quantity of raw material in the primary zone with respect to the processing taking place for the first quantity of raw material in the secondary zone;
dispensing the second quantity of raw material processed in the primary zone into the secondary zone for shredding and/or cooking and/or cooling according to the recipe; and
repeating the precedent steps a plurality of times depending on the information from the recipe parameters until a certain homogeneous or heterogeneous mixture is achieved.

14. Method for preparing an edible food or beverage product starting from dehydrated raw material according to claim 13 wherein a final processing is applied in the secondary zone to the mixture therein comprised, to get a homogeneous or heterogeneous mixture according to the recipe targeted and obtain a final product.

15. Method according to claim 13 wherein the user can add food or beverage products into the secondary zone, at any time of the processing carried out in the apparatus.

16. Method according to claim 13 wherein the database defines the following features for the preparation of the end product in the apparatus:
ordering raw products to be dispensed into and processed in the primary zone;
processing requirements needed per raw product dispensed in the primary zone;
timing and/or triggering values for dispensing the products from the primary zone into the secondary zone; and
processing requirements needed per product and/or mixture into the secondary zone.
